(19) United States
(12) Patent Application Publication
(10) Pub. No.: US 2006/0262256 A1
(43) Pub. Date: Nov. 23, 2006

(54) Liquid crystal display

(75) Inventor: Sang-Il Kim, Gyeonggi-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/304,879

(22) Filed: Dec. 14, 2005

(30) Foreign Application Priority Data
May 18, 2005 (KR) 10-2005-0041476

(51) Int. Cl. G02F 1/1335

(52) U.S. Cl. 349/114

(57) ABSTRACT

A transflective liquid crystal display with a transmission area and a reflection area includes a first substrate, a second substrate that is opposite to the first substrate, a transparent electrode formed on the first substrate, a reflective electrode formed on the transparent electrode and placed at the reflection area, a retardation layer formed on the second substrate, a first polarizer and a second polarizer that are respectively attached to outer surfaces of the first and second substrates, and a compensation film provided between the first substrate and the first polarizer. The retardation layer is formed to correspond to the reflection areas and the compensation film is interposed between the lower polarizer and the lower substrate, so that the viewing angle of the transflective LCD becomes wider. Since the retardation layer is formed inside the LCD, other retardation layers are not additionally required. Accordingly, production cost of the LCD is reduced.

### BACKGROUND OF THE INVENTION

(a) Field of the Invention

The present invention relates generally to a liquid crystal display and, more particularly, to a transflective liquid crystal display.

(b) Description of the Related Art

Recently, liquid crystal displays (LCDs) have been the most widely used among flat panel display devices. Generally, an LCD includes a pair of panels individually having electrodes on their inner surfaces, and a liquid crystal (LC) layer having dielectric anisotropy interposed between the panels. In the LCD, a variation of the voltage difference between the field generating electrodes, i.e., the variation in the strength of an electric field generated by the electrodes, changes the transmittance of light passing through the LCD, and thus desired images are obtained by controlling the voltage difference between the electrodes.

Depending on the kind of light source used for image display, the LCDs are divided into three types: transmissive, reflective, and transflective LCDs. In the transmissive LCDs, the pixels are illuminated from behind using a backlight. In the reflective LCDs, the pixels are illuminated from the front using incident light originating from the ambient environment. Transflective LCDs combine transmissive and reflective characteristics. Under medium light conditions, such as an indoor environment, or under complete darkness conditions, these LCDs are operated in a transmissive mode, while under very bright conditions, such as outdoor environment, they are operated in a reflective mode.

In the LCD, two polarizers, which transmit only a specific polarized component of incident light, are respectively attached to the outer surface of the two panels, and a quarter-wave retardation film is disposed between an upper-positioned panel of the two and an upper-positioned polarizer such that an optical axis thereof is oriented horizontally. In this structure, the retardation film converts linearly polarized light into circularly polarized light, and vice versa, by generating a phase difference equivalent to a quarter wavelength between two polarized components. In addition, a wide-band retardation film is attached to the retardation film to create circularly or linearly polarized light over the whole visible wavelength range in a reflective mode.

The reflective LCD adopting such a retardation film can operate in a reflective mode or in a transmissive mode. However, this LCD has some drawbacks in that viewing angle becomes narrower due to the retardation film and production cost increases since the wide-band retardation film is additionally required.

### SUMMARY OF THE INVENTION

According to an aspect of the present invention, an LCD with a transmission area and a reflection area is provided, which includes: a first substrate; a second substrate that is opposite to the first substrate; a transparent electrode formed on the first substrate; a reflective electrode formed on the transparent electrode and placed at a reflection area; a retardation layer formed on the second substrate; a first polarizer and a second polarizer that are respectively attached to outer surfaces of the first and second substrates; and a compensation film provided between the first substrate and the first polarizer.

Here, when the reflection area means a display region corresponding to the reflective electrode, the transmission area means the remaining display region that is not the reflection area, and the retardation layer is placed at the reflection area.

The LCD may be further comprised of an optically isotropic medium layer that is formed in the second substrate only at the transmission area or throughout the transmission area and the reflection area.

The first polarizer may have a transmission axis that is perpendicular to a transmission axis of the second polarizer.

The compensation film may have a slow axis that is formed in the same direction as the transmission axis of the first polarizer.

The compensation film may satisfy the following equations:

$$40 \leq {R}_{O} = ( {n}_{x} - {n}_{y} ) \times d \leq 60 , and$$

$$150 \leq {R}_{th} = ( \frac{( {n}_{x} + {n}_{y} )}{2} - {n}_{z} ) \times d \leq 250$$

where nₓ, n_{y}, and n_{z} are refractive indices of the compensation film when light passes through it in X, Y, and Z directions, d is a thickness of the compensation film, Rₜₕ is a retardation value in a thickness direction, and Rₒ is a retardation value in a direction perpendicular to the thickness direction of the compensation film.

Here, Rₒ may be about 50 and Rₜₕ may be about 200, and the compensation film may be a biaxial film.

Meanwhile, the retardation layer may be a A/4 plate, and may have a fast axis that is formed at ±45° to the transmission axes of first and second polarizers. The retardation layer may be formed at the reflection area of the second substrate.

The LCD may further include a set of three color filters formed on the second substrate. The three color filters may be a red color filter, a green color filter, and a blue color filter. Any color filter among the three color filters, which is formed at the transmission area, may be formed more thickly than the others formed at the reflection area.

The retardation layer may include three portions related to the three color filters, and the three portions have different thicknesses depending upon the kind of related color filters.

The LCD may further include a common electrode formed on the second substrate.

In this structure, a distance between the common electrode and the reflection electrode, which are formed at the reflection area, may be shorter than a distance between the common electrode and the transparent electrode, which are formed at the transmission area. Here, the distance at the reflection area may be half of the distance at the transmission area.

The compensation film may be coated on either surface of the first polarizer, and a pixel electrode formed by the transparent electrode and the reflective electrode may have an uneven top surface.

### BRIEF DESCRIPTION OF THE DRAWINGS

The above objects and other advantages of the present invention will become more apparent by describing the preferred embodiments thereof in more detail with reference to the accompanying drawings.

FIG. 1 is a layout view of an LCD according to an embodiment of the present invention.

FIG. 2 is a cross-sectional view cut along II-II′ of FIG. 1.

FIG. 3 is a cross-sectional view cut along III-III′ of FIG. 1.

FIG. 4, FIG. 6, FIG. 8, and FIG. 10 are layout views showing intermediate process steps to manufacture an LCD according to an embodiment of the present invention.

FIG. 5, FIG. 7, FIG. 9, FIG. 11, FIG. 12 and FIG. 13 are schematic cross-sectional views cut along V-V′, VII-VII′, IX-IX′, and XI-XI′ of FIG. 4, FIG. 6, FIG. 8, and FIG. 10, respectively.

FIG. 14 through FIG. 18 are schematic cross-sectional views showing process steps to manufacture a common electrode panel of an LCD according to an embodiment of the present invention.

FIG. 19 is a cross-sectional view of a set of RGB pixels of an LCD according to an embodiment of the present invention.

FIG. 20 shows the upper polarizer attached to an adhesive layer according to an embodiment of the present invention.

FIG. 21 shows the lower polarizer attached to a compensation layer and an adhesive layer according to an embodiment of the present invention.

FIG. 22 shows the contrast ratio of an LCD according to an embodiment of the present invention.

### DETAILED DESCRIPTION OF THE PREFERRED EMBODIMENTS

Preferred embodiments of the present invention will be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of the layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

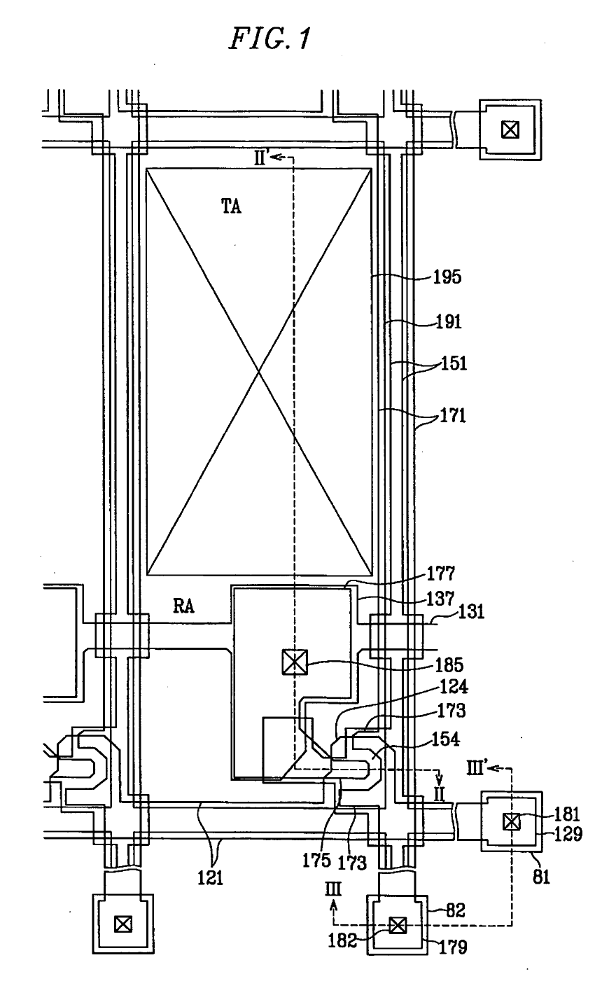

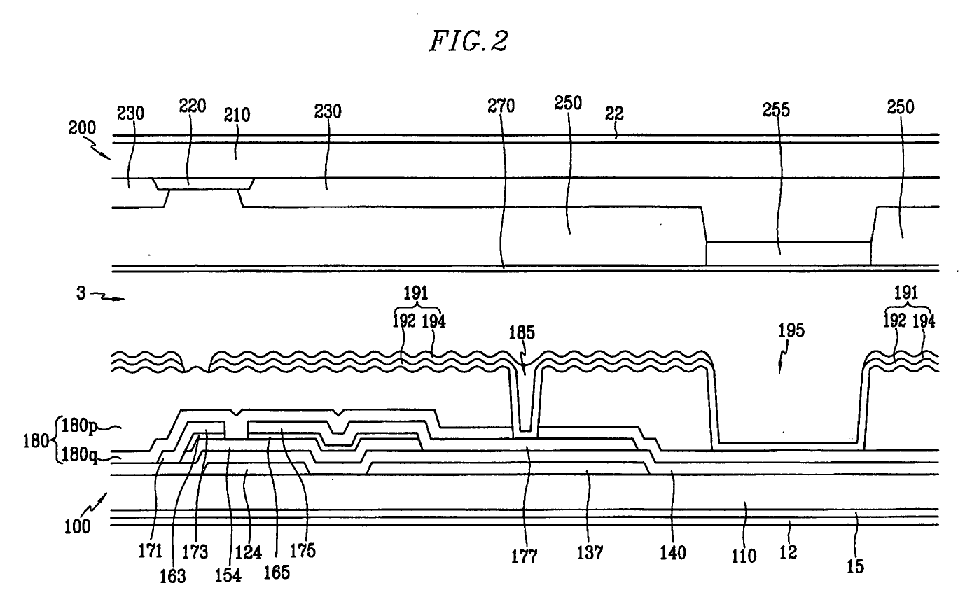

Hereinafter, an LCD according to an embodiment of the present invention will be described in detail with reference to FIG. 1 through FIG. 3.

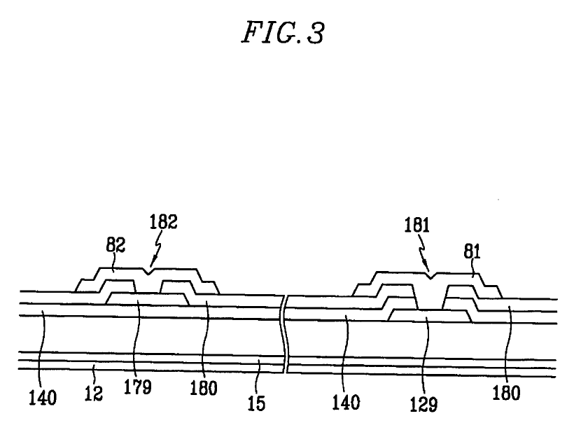

FIG. 1 is a layout view of an LCD according to an embodiment of the present invention, and FIG. 2 and FIG. 3 are cross-sectional views cut along II-II′ and III-III′ of FIG. 1, respectively.

Referring to FIG. 1 to FIG. 3, the LCD of this embodiment includes a TFT array panel 100 and a common electrode panel 200 facing each other, and an LC layer 3 interposed therebetween. The LC layer 3 includes LC molecules that are aligned perpendicular or parallel to the surfaces of the two panels 100 and 200.

The TFT array panel 100 is configured as follows.

A plurality of gate lines 121 and a plurality of storage electrode lines 131 are formed on an insulating substrate 110 made of transparent glass or plastic.

The gate lines 121 for transmitting gate signals extend substantially in a horizontal direction. Each gate line 121 includes a plurality of gate electrodes 124 protruding upward and an end portion 129 having a relatively large dimension to be connected to a different layer or an external device. Gate drivers (not shown) for generating the gate signals may be mounted on a flexible printed circuit film (not shown) attached to the substrate 110, or directly on the substrate 110. Otherwise, the gate drivers may be integrated into the substrate 110. In this case, the gate lines 121 are directly connected to the gate drivers.

The storage electrode lines 131 for receiving a predetermined voltage extend substantially parallel to the gate lines 121. Each storage electrode line 131 is placed between two adjacent gate lines, particularly, closer to the lower-positioned gate line of the two. Each storage electrode line 131 includes a plurality of storage electrodes 137 expanding upward and downward. The form and arrangement of the storage electrode lines 131 may be freely varied.

The gate lines 121 and the storage electrode lines 131 are preferably made of an aluminum—(Al) containing metal such as Al and an Al alloy, a silver—(Ag) containing metal such as Ag and a Ag alloy, a copper—(Cu) containing metal such as Cu and a Cu alloy, a molybdenum—(Mo) containing metal such as Mo and a Mo alloy, chrome (Cr), titanium (Ti), or tantalum (Ta). The gate lines 121 and the storage electrode lines 131 may be configured as a multi-layered structure, in which at least two conductive layers (not shown) having different physical properties are included. In this case, one of the two layers is made of a low resistivity metal, such as an Al-containing metal, an Ag-containing metal, and a Cu-containing metal, in order to reduce delay of the signals or voltage drop in the gate lines 121 and the storage electrode lines 131. The other is made of a material having prominent physical, chemical, and electrical contact properties with other materials such as indium tin oxide (ITO) and indium zinc oxide (IZO). For example, Mo-containing metals, Cr, Ta, Ti, etc., may be used for the formation of the same layer. Desirable examples of the combination of the two layers are a lower Cr layer and an upper Al (or Al alloy) layer, and a lower Al (or Al alloy) layer and an upper Mo (or Mo alloy) layer. Besides the above-listed materials, various metals and conductors can be used for the formation of the gate lines 121 and the storage electrode lines 131.

All lateral sides of the gate lines 121 and the storage electrode lines 131 preferably slope in the range from about 30° to 80° to the surface of the substrate 110.

A gate insulating layer 140, made of silicon nitride (SiNx) or silicon oxide (SiO₂), is formed on the gate lines 121 and the storage electrode lines 131.

A plurality of linear semiconductors 151 made of hydrogenated amorphous silicon (abbreviated as “a-Si”) or polysilicon are formed on the gate insulating layer 140. Each linear semiconductor 151 extends substantially in a vertical direction, and includes a plurality of projections 154 that extend along the respective gate electrodes 124. The linear semiconductors 151 are enlarged in the vicinities of the gate lines 121 and the storage electrode lines 131 to cover them widely.

A plurality of linear ohmic contacts 161 and island-shaped ohmic contacts 165 are formed on the linear semiconductors 151. The ohmic contacts 161 and 165 may be made of N+ hydrogenated amorphous silicon that is highly doped with N-type impurities such as phosphorus (P) or silicide. The linear ohmic contacts 161 include a plurality of projections 163. A set of a projection 163 and an island-shaped ohmic contact 165 are placed on the projection 154 of the semiconductor 151.

All lateral sides of the semiconductors 151 and the ohmic contacts 161 and 165 slope in the range from about 30° to 80° to the surface of the substrate 110.

A plurality of data lines 171 and a plurality of drain electrodes 175 are formed on the ohmic contacts 161 and 165 and the gate insulating layer 140.

The data lines 171 for transmitting data signals extend substantially in a vertical direction to be crossed with the gate lines 121 and the storage electrode lines 131. Each data line 171 includes a plurality of source electrodes 173 extending toward the respective gate electrodes 124, and an end portion 179 having a relatively large dimension to be connected to a different layer or an external device. Data drivers (not shown) for generating the data signals may be mounted on a flexible printed circuit film (not shown) attached to the substrate 110, or directly on the substrate 110. Otherwise, the data drivers may be integrated into the substrate 110. In this case, the data lines 171 are directly connected to the gate drivers.

The drain electrodes 175 separated from the data lines 171 are opposite to the source electrodes 173, centering on the gate electrodes 124. Each drain electrode 175 includes an expansion 177 having a relatively large dimension and a bar-shaped end portion. The expansions 177 of the drain electrodes 175 are overlapped with the storage electrodes 137 of the storage electrode lines 131, and the bar-shaped end portions are partially surrounded with the curved source electrodes 173.

A gate electrode 124, a source electrode 173, a drain electrode 175, and a projection 154 of the semiconductor 151 form a thin film transistor (TFT). A TFT channel is formed in the projection 154 provided between the source electrode 173 and the drain electrode 175.

The data lines 171 and the drain electrodes 175 are preferably made of a refractory metal, such as Mo, Cr, Ta, or Ti, or alloys thereof, and may be configured as a multi-layered structure including a refractory metal layer (not shown) and a low resistivity conductive layer (not shown). A desirable example of the multi-layered structure is a lower layer made of one among Cr, Mo, and a Mo alloy, and an upper layer made of Al or an Al alloy. Another example is a lower layer made of Mo or a Mo alloy, an intermediate layer made of Al or an Al alloy, and an upper layer made of Mo or a Mo alloy. Besides the above-listed materials, various metals and conductors can be used for the formation of the data lines 171 and the drain electrodes 175.

All lateral sides of the data lines 171 and the drain electrodes 175 preferably slope in the range from about 30° to 80° to the surface of the substrate 110.

The ohmic contacts 161 and 165 exist only between the underlying semiconductors 151 and the overlying data lines 171 and between the overlying drain electrodes 175 and the underlying semiconductors 151, in order to reduce contact resistance therebetween. Most portions of the linear semiconductors 151 are formed more narrowly than the data lines 171, but partial portions thereof are enlarged in the vicinities of places to be crossed with the gate lines 121, as previously mentioned, in order to prevent the data lines 171 from being shorted. The linear semiconductors 151 are partially exposed at places where the data lines 171 and the drain electrodes 175 do not cover them, as well as between the source electrodes 173 and the drain electrodes 175.

A passivation layer 180 is formed on the data lines 171, the drain electrodes 175, and the exposed portions of the semiconductors 151. The passivation layer 180 is configured as a double-layered structure including a lower layer 180q made of an inorganic insulator, such as SiNx or SiO₂, and an upper layer 180p made of an organic insulator. Preferably, the organic insulator for the upper passivation layer 180p has a low dielectric constant of below 4.0 and/or has photosensitivity. The upper passivation layer 180p is provided with apertures (i.e., transmission windows 195) where the lower passivation layer 180q is partially exposed, and the top surface of the upper passivation layer 180p is uneven. The passivation layer 180 may be configured as a single layer made of an inorganic insulator or an organic insulator.

The passivation layer 180 is provided with a plurality of contact holes 182 and 185, through which the end portions 179 of the data lines 171 and the drain electrodes 175 are exposed, respectively. A plurality of contact holes 181 are formed in the passivation layer 180 and the gate insulating layer 140, and the end portions 129 of the gate lines 121 are exposed therethrough.

A plurality of pixel electrodes 191 and a plurality of contact assistants 81 and 82 are formed on the passivation layer 180.

Each pixel electrode 191 has an uneven profile caused by the uneven top surface of the upper passivation layer 180p and is comprised of a transparent electrode 192 and a reflective electrode 194 overlying the transparent electrode 192. The transparent electrodes 192 are made of a transparent conductor such as ITO or IZO, and the reflective electrodes 194 are made of an opaque and reflective conductor such as Al, Cr, Ag, or alloys thereof. However, the reflective electrodes 194 may be configured as a double-layered structure. In this case, upper layers (not shown) are made of a low resistivity metal, such as Al, an Al alloy, Ag, or a Ag alloy, and lower layers (not shown) are made of a material having prominent contact properties with ITO and IZO, such as a Mo-containing metal, Cr, Ta, Ti, or the like.

Each reflective electrode 194 is placed at the aperture of the upper passivation layer 180p, having a transmission window 195 for exposing the transparent electrode 192. Each reflective electrode 194 exists only on a partial portion of the transparent electrode 192, so that the remaining portion of the transparent electrode 192 is exposed. The exposed transparent electrode 192 is placed at the aperture of the upper passivation layer 180p.

The pixel electrodes 191 are physically and electrically connected to the drain electrodes 175 through the contact holes 185 in order to receive data voltages from the drain electrodes 175. The pixel electrodes 191 supplied with the data voltages generate electric fields in cooperation with a common electrode 270 of the common electrode panel 200, determining the orientations of LC molecules in the LC layer 3 interposed between the two electrodes 191 and 270. According to the orientations of the LC molecules, the polarization of light passing through the LC layer 3 is varied. Also, a set of the pixel electrode 190 and the common electrode 270 forms an LC capacitor capable of storing the applied voltage after the TFT is turned off.

In a transreflective LCD, there are transmission areas TA defined by the transparent electrodes 192 and reflection areas RA defined by the reflective electrodes 194. In more detail, a transmission area TA means a section of portions disposed straight on and under the transmission window 195 in the TFT array panel 100, the common electrode panel 200, and the LC layer 3, while a reflection area RA means a section of portions disposed straight on and under the reflective electrode 194. In the transmission areas TA, internal light emitted from the rear of the LCD passes through the TFT panel 100 and the LC layer 3 and then exits the common electrode panel 200 in an intact state, thus contributing to the display images. In the reflection areas RA, exterior light supplied through the front of the LCD is reflected by the reflective electrodes 194 of the TFT panel 100 and exists in the common electrode panel 200 after passing through the LC layer 3, thus contributing to the display images. In this structure, the uneven profiles of the reflective electrodes 194 disperse light more efficiently, improving reflectance of the light.

The thickness of the LC layer 3 (or the cell gap) corresponding to the transmission areas TA is double of the thickness of the LC layer 3 corresponding to reflection areas RA, since the transmission areas TA have no upper passivation layer 180p.

The pixel electrodes 191 and the expansions 177 of the drain electrodes 175, connected to the pixel electrodes 192, are overlapped with the storage electrodes 131 and the storage electrodes 137 of the storage electrode lines 131. To enhance the voltage storage ability of the liquid crystal capacitors, storage capacitors are further provided. The storage capacitors are implemented by overlapping the pixel electrodes 191 and the drain electrode 175 electrically connected thereto with the storage electrode lines 131.

The contact assistants 81 and 82 are connected to the end portions 129 of the gate lines 121 and the end portions 179 of the data lines 171 through the contact holes 181 and 182, respectively. The contact assistants 81 and 82 are provided to supplement adhesion between the exposed end portions 129 and 179 and exterior devices, and to protect them.

The common electrode panel 200, facing the TFT array panel 100, is configured as follows.

A light blocking member 220 called a “black matrix” is provided on an insulating substrate 210 made of transparent glass or plastic. The light blocking member 220 prevents light from leaking out through barriers between the pixel electrodes 191, while defining aperture regions facing the pixel electrodes 191.

A plurality of color filters 230 is formed on the substrate 210 having the light blocking member 221. Most of them are placed within the aperture regions delimited by the light blocking member 220. The color filters 230 extend along the pixel electrodes 191 substantially in a vertical direction, each exhibiting one among red, green, blue colors. The color filters 230 are connected to one another, having the shape of stripes. The color filters 230 corresponding to transmission areas TA have different thicknesses from the color filters 230 corresponding to the reflection areas RA. Generally, in the transmission areas TA, light passes the common electrode 270 and the color filters 230 only once, while it passes twice by reflection in the reflection areas RA, so that the sensation of color may be differently recognized between the two areas TA and RA. A method to make uniform color sensation in that case is to form the color filters 230 corresponding to transmission areas TA more thickly than the color filters 230 corresponding to the reflection areas RA. Another method is to provide light holes (i.e., regions without the color filter) in the color filters 230 corresponding to the reflection areas RA.

A retardation layer 250 and an isotropic medium layer 255 are formed on the color filters 230 and the light blocking member 220. In this structure, it is preferable that the retardation layer 250 exists only within the reflection areas RA, while the isotropic medium layer 255 exists only within the transmission areas TA, as shown in the FIG. 2. However, the isotropic medium layer 255 may also be formed at the reflection areas RA.

The retardation layer 250 has a slow axis and a fast axis. Accordingly, when a light passes through the retardation layer 250, the light element polarized along the fast axis of the retardation layer 250 obtains a faster phase than that of the light element polarized along the slow axis. In this case, a preferable phase difference between the two axes is a quarter-wave. Thus, the retardation layer 250 is a λ/4 plate. Also preferably, the two axes are perpendicular to each other, and they are formed at ±45° to transmission axes of the polarizers 12 and 22, respectively.

Meanwhile, the isotropic medium layer 255 does not result in the phase difference when light passes through it. In other embodiments, if the isotropic medium layer 255 is formed to cover the retardation layer 250, it is possible to planarize the inner surface of the common electrode panel 200 using such an isotropic medium layer 255.

A common electrode 270 is formed on the retardation layer 250 and the isotropic medium layer 255. The common electrode 270 is preferably made of a transparent conductor such as ITO or IZO.

Two alignment layers (not shown) are respectively formed on the inner surfaces of the two panels 100 and 200 to align the LC molecules in the LC layer 3, while two polarizers 12 and 22 are respectively attached to the outer surfaces of the two panels 100 and 200.

The transmission axes of the two polarizers 12 and 22 are disposed perpendicular to each other. As previously illustrated, the slow axis and fast axis of the retardation layer 250 are preferably formed at ±45° to the transmission axes of the polarizers 12 and 22, respectively.

A compensation film 15 is formed between the lower insulting substrate 110 and the lower polarizer 12. Preferably, a biaxial film, which shows different refractive indices nₓ, n_{y}, and n_{z} when light passes through it in x, y, and z directions, is used as the compensation film 15. Also preferably, such a biaxial compensation film 15 satisfies the following equations:

$$\begin{matrix}40 \leq {R}_{O} = ( {n}_{x} - {n}_{y} ) \times d \leq 60 , and & ( 1 ) \\ 150 \leq {R}_{th} = ( \frac{( {n}_{x} + {n}_{y} )}{2} - {n}_{z} ) \times d \leq 250 & ( 2 )\end{matrix}$$

where d is a thickness of the compensation film 15, Rₜₕ is a retardation value in a thickness direction, and Rₒ is a retardation value in a direction perpendicular to the thickness of the compensation film 15. Here, it is preferable that Rₒ is about 50 and Rₜₕ is about 200. It is also preferable that the slow axis (x) of the compensation film 15 is parallel to the transmission axis of the lower polarizer 12.

The LC layer 3 is aligned parallel or perpendicular to the surfaces of the two panels 100 and 200.

A plurality of spacers (not shown) may be provided between the TFT array panel 100 and the common electrode panel 200 to create and maintain an gap therebetween.

Also, sealant may be provided between the TFT array panel 100 and the common electrode panel 200 to combine them. In this case, the sealant is applied to opposite edges of the two panels 100 and 200.

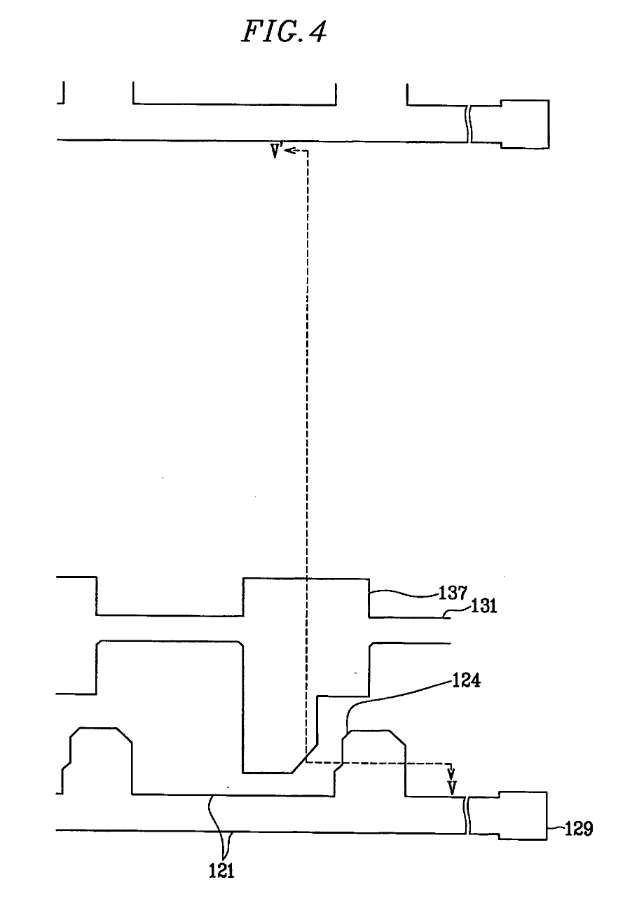

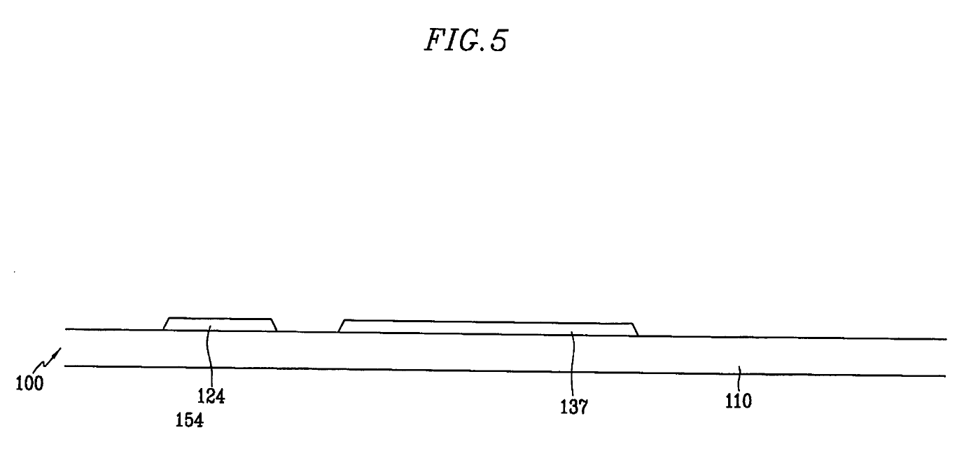

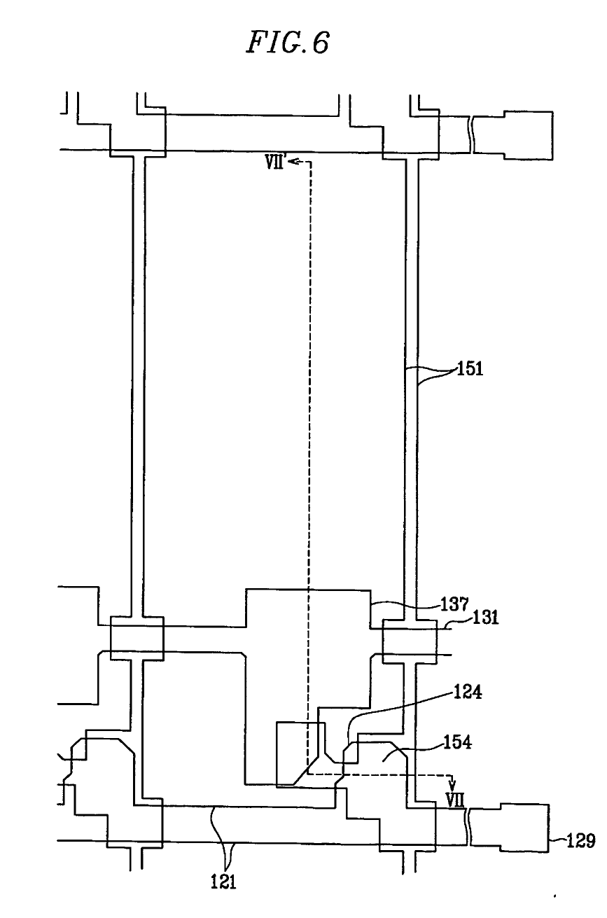

Hereinafter, a manufacturing method of the above-mentioned LCD will be described in detail with reference to FIG. 4 through FIG. 13.

FIG. 4 through FIG. 13 are schematic cross-sectional views showing process steps to manufacture an LCD according to an embodiment of the present invention.

The TFT array panel 100 is manufactured as follows.

A conductive layer is first formed on an insulating substrate 110 by a method such as sputtering. Here, the conductive layer is made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti, or Ta.

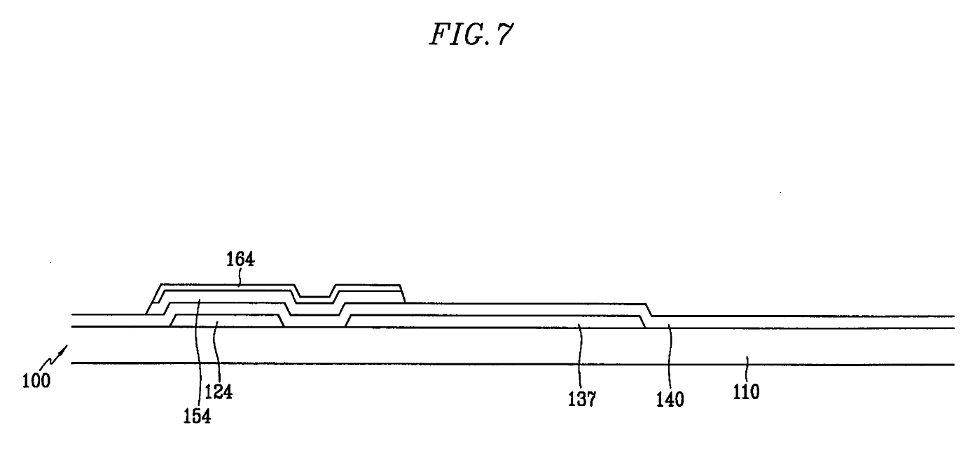

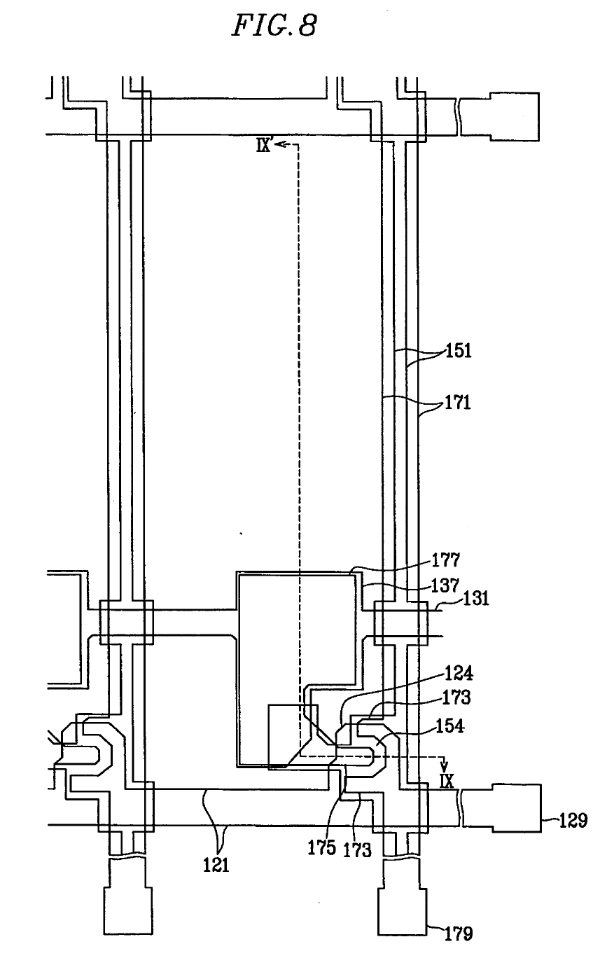

Next, the conductive layer is selectively etched by photolithography to form a plurality of gate lines 121 with gate electrodes 124 and end portions 129, and a plurality of storage electrode lines 131 with storage electrodes 137, as shown in FIG. 4 and FIG. 5.

Subsequent to the formation of the gate lines 121 and the storage electrode lines 131, a gate insulating layer 140 made of SiNₓ or the like, a hydrogenated amorphous silicon layer, and an N+ impurity-doped amorphous silicon layer are successively deposited on the resultant structure of FIG. 5 by low temperature chemical vapor deposition (LPCVD) and plasma enhanced chemical vapor deposition (PECVD). The hydrogenated amorphous silicon layer and the doped amorphous silicon layer are then selectively etched by photolithography, so that a plurality of linear semiconductors 151 with a plurality of projections 154, and a plurality of ohmic contact patterns 164 are formed as shown in FIG. 6 and FIG. 7.

Next, a conductive layer, made of a low resistivity metal such as Cr, a Mo-containing metal, Ta, Ti, or the like, is formed on the resultant structure of FIG. 7 by a deposition method such as sputtering or the like. As shown in FIG. 8 and FIG. 9, the conductive layer is then selectively etched by photolithography to form a plurality of data lines 171 with source electrodes 173, and a plurality of drain electrodes 175 with expansions 177.

Subsequent to the formation of the data lines 171 and drain electrodes 175, the exposed portions of the ohmic contact patterns 164, which are not covered with the data lines 171 and the drain electrodes 175, are removed. As a result, as shown in FIG. 9, each ohmic contact pattern 164 is divided into two ohmic contacts 163 and 165, and the underlying linear semiconductor 151 is partially exposed between the two contacts 163 and 165. Preferably, an O₂ plasma process is then performed to stabilize the surfaces of the exposed semiconductors 154.

Next, as shown in FIG. 10 and FIG. 11, a lower passivation layer 180q made of SiNx or the like is formed on the resultant structure of FIG. 9 by chemical vapor deposition (CVD), and an organic material is then coated on the lower passivation layer 180p, thereby forming an upper passivation layer 180p. Next, the upper passivation layer 180p is selectively exposed to light through a photo-mask and then developed. As a result, a plurality of contact holes 185, through which the lower passivation layer 180q overlying the expansions 177 of the drain electrodes 175 is exposed, are formed in the upper passivation layer 180p, and an uneven pattern is formed at the surface of the upper passivation layer 180p. Also, a plurality of transmission windows 195 are formed in the upper passivation layer 180p. The areas where the transmission windows 195 are formed function as transmission areas TA. Next, the lower passivation layer 180q is patterned by photolithography using a photoresist mask, so that a plurality of contact holes 185 are completed.

Subsequent to the formation of the contact holes 185, a transparent material such as ITO or IZO is deposited on the passivation layer 180. The deposited layer is then patterned using a mask, thereby forming a plurality of transparent electrodes 192, connected to the drain electrodes 175 through the contact holes 185, as shown in FIG. 12.

Next, an opaque metallic material, such as Al, Ag, or the like, is deposited on the transparent electrodes 192. The deposited metal layer is then patterned to remain only in the reflection areas RA. As a result, a plurality of reflective electrodes 194 are formed as shown in FIG. 12.

Next, an alignment layer (not shown) is formed on the reflective electrodes 194 and the transparent electrodes 192 that are exposed at the transmission areas TA.

Subsequently, as shown in FIG. 13, a compensation film 15 and a lower polarizer 12 are attached to the outer surface of the lower insulating substrate 110. At this time, a slow axis of the compensation film 15 and a transmission axis of the polarizer 12 are parallel to one another. Various methods can be used to form the structure of the compensation film 15 and the lower polarizer 12. An available method (as shown in FIG. 21) is that the compensation film 15 is bonded to the lower polarizer 12 using an adhesive after being stretched, and is then re-bonded to the outer surface of the lower insulating substrate 110. Another available method is to form the compensation film 15 on either surface of the lower polarizer 12 and then bond the combined structure to the outer surface of the substrate 110 using an adhesive.

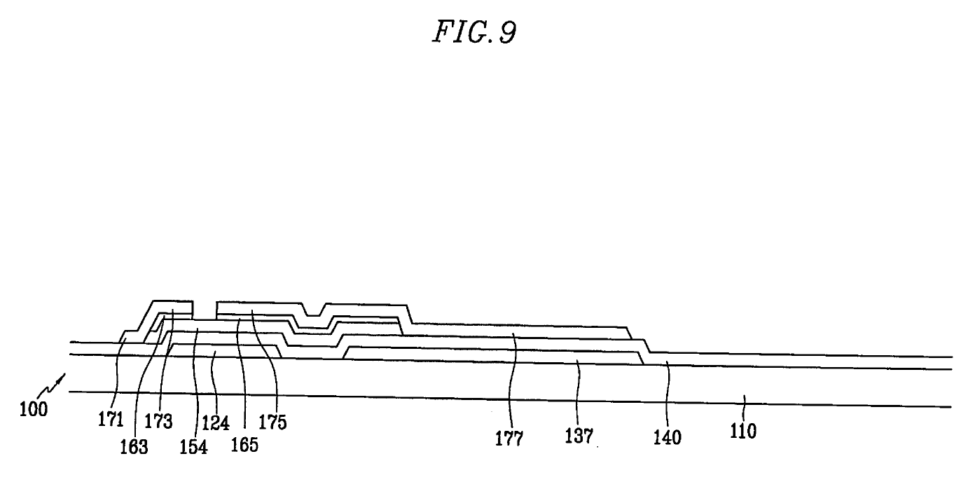

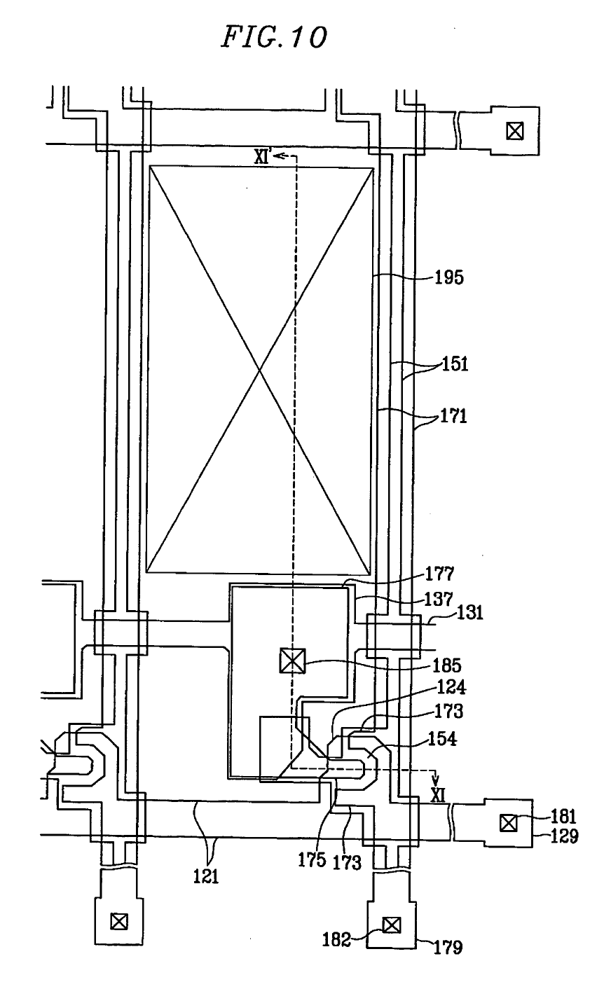

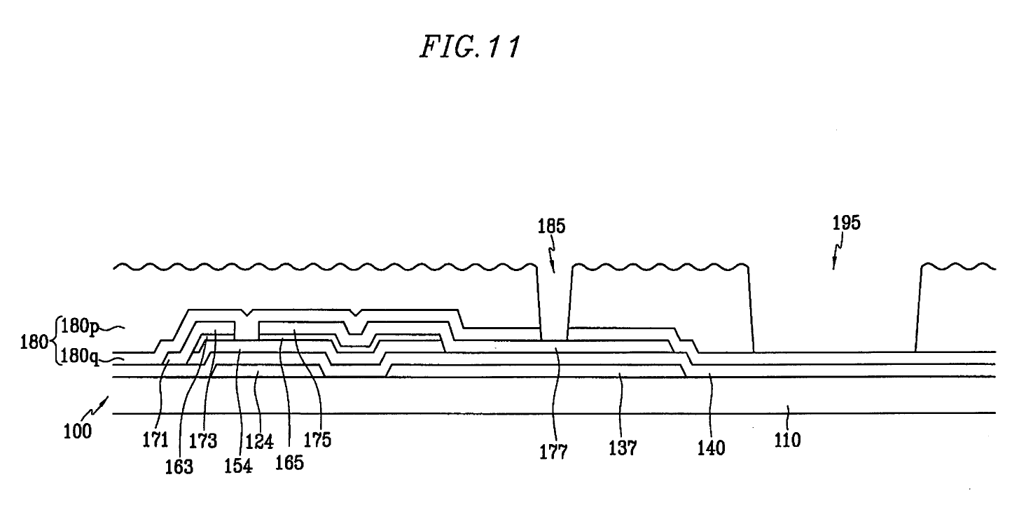

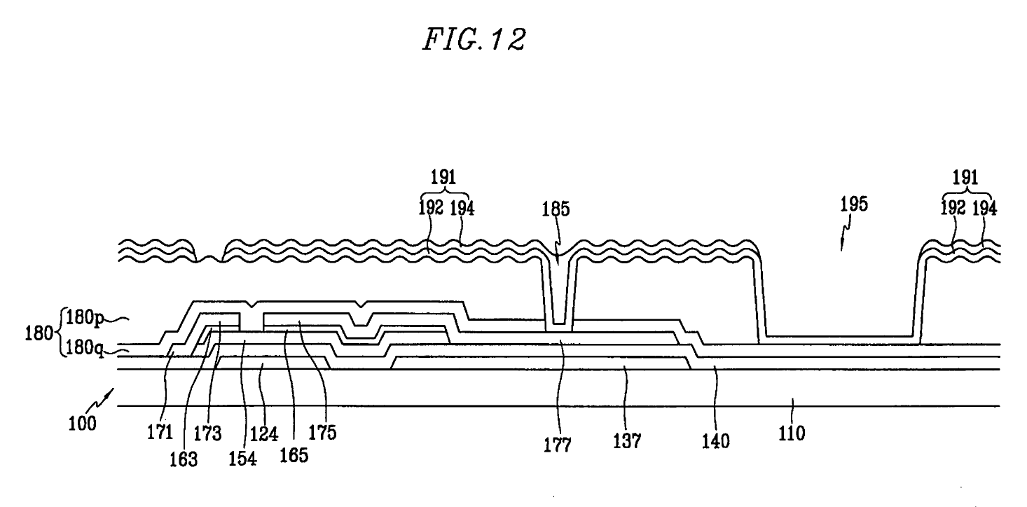

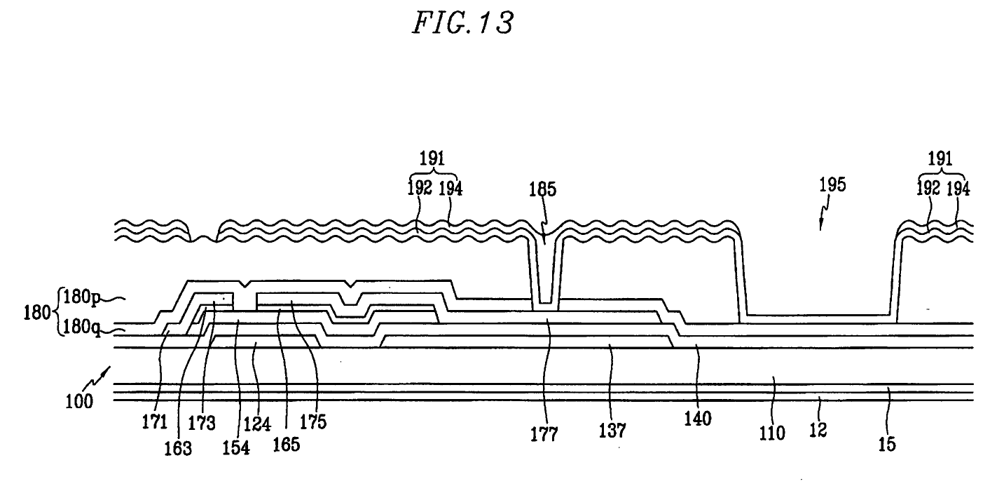

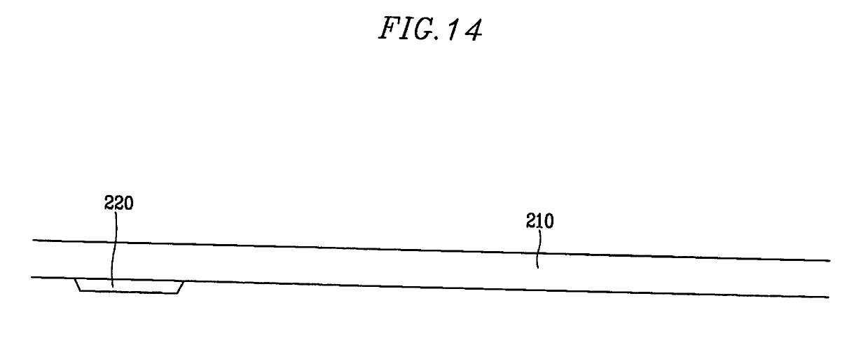

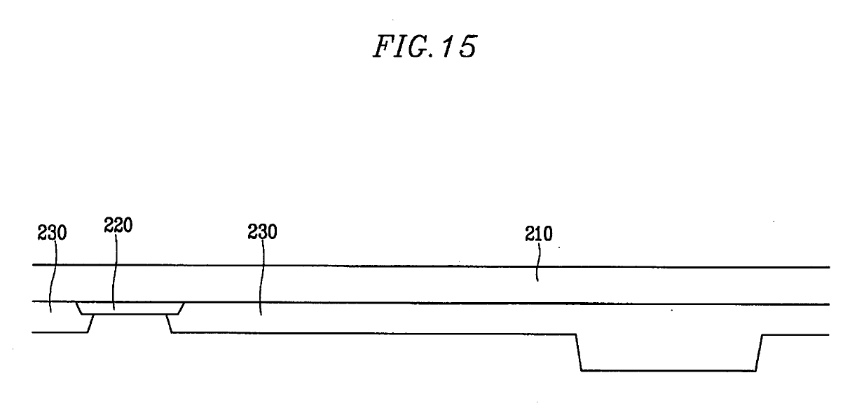

Hereinafter, a manufacturing method of the common electrode panel 200 shown in FIG. 1 through FIG. 3 will be described in detail with reference to FIG. 14 through FIG. 18.

A layer of a metal such as Cr or the like, or a double layer of a metallic oxide and a metal is first deposited on an upper insulating substrate 210, and the deposited layer is patterned by photolithography to form a black matrix 220, as shown in FIG. 14.

Next, a plurality of color filters 230 are formed on the black matrix 220 in a manner such that most of them are placed within aperture regions delimited by the black matrix 220. The color filters 230 exhibit three primary colors, red (R), green (G), and blue (B), and are formed more thickly than the black matrix 220.

These color filters 230 are obtained through some process steps. That is, a pigment-dispersed photoresist with a color spectral property is coated on the insulating substrate 210 including the black matrix 220. The photoresist layer is baked on a hot plate, and photolithography is then performed, resulting in the formation of the RGB color filters 230. Here, the color filters 230 have different thicknesses depending on their positions. That is, preferably, the color filters 230 corresponding to the transmission areas TA are formed more thickly than those of the reflection areas RA.

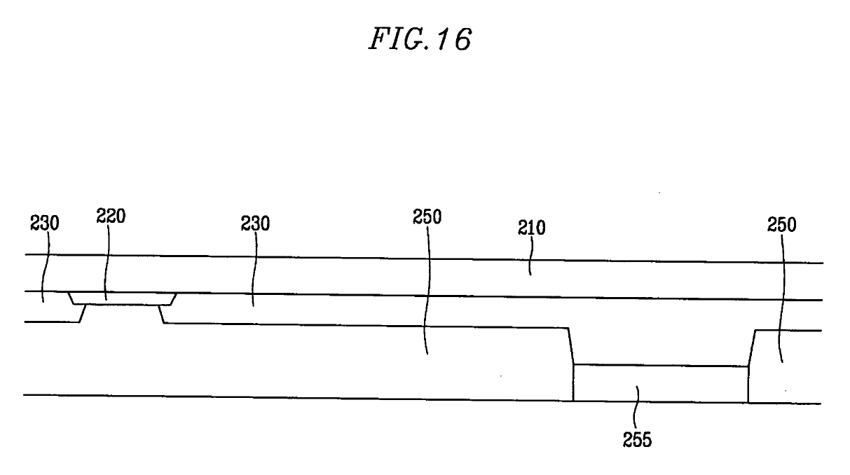

Subsequent to the formation of the color filters 230, as shown in FIG. 16, a retardation layer 250 and an isotropic medium layer 255 are formed on the substrate 210 including the black matrix 220 and the color filters 230. The order of the formation between them is not critical. However, it is preferable that the retardation layer 250 exists only within the reflection areas RA.

The retardation layer 250 and the isotropic medium layer 255 may be individually formed through different processes, or formed together in the same process.

The first method is carried out as follows.

First, a photo-sensitive material is coated on the black matrix 220 and the color filters 230 to form an alignment layer, and the alignment layer then is partially removed. The removed portions will be filled with a material for the formation of an optical isotropic medium layer 255 in a subsequent process. The remaining portions of the alignment layer are then exposed to light, thereby forming an alignment axis at the alignment layer. The alignment axis is preferably formed at ±45° to the transmission axes of the polarizers 12 and 22. Next, LC molecules are coated on the alignment layer, and the molecules are then cured by light, thereby forming a retardation layer 250.

Next, an optically isotropic material is provided at regions without the retardation layer 250, thereby forming an isotropic medium layer 255. That is, after the deposition of the isotropic material, the deposited layer placed directly on the retardation layer 250 is patterned and removed. According to an embodiment of the present invention, the isotropic medium layer 255 is formed at regions without the retardation layer 250. Otherwise, it may be formed on the retardation layer 250. This method is advantageous in that the production process is simplified since patterning the isotropic medium layer 255 is omitted, and the inner surface of the common electrode panel 200 is planarized.

The second method is carried out as follows.

An alignment layer is formed on the black matrix 220 and the color filters 230. The alignment layer is then exposed to light to form an alignment axis thereof. The desirable alignment axis is disposed at ±45° to the transmission axes of the polarizers 12 and 22. Next, LC molecules are coated on the entire substrate 210 with the alignment layer. The molecular layer is selectively exposed to light through a mask for the formation of a retardation layer 250, and the exposed portions are thus cured. Subsequently, the LC molecules are changed to an optically isotropic material at above an isotropy temperature of the molecules. The optically isotropic material is selectively exposed to light through a mask for the formation of an isotropic medium layer 255, and the exposed portions are thus cured. As a result, a retardation layer 250 and an isotropic medium layer 255 are completed.

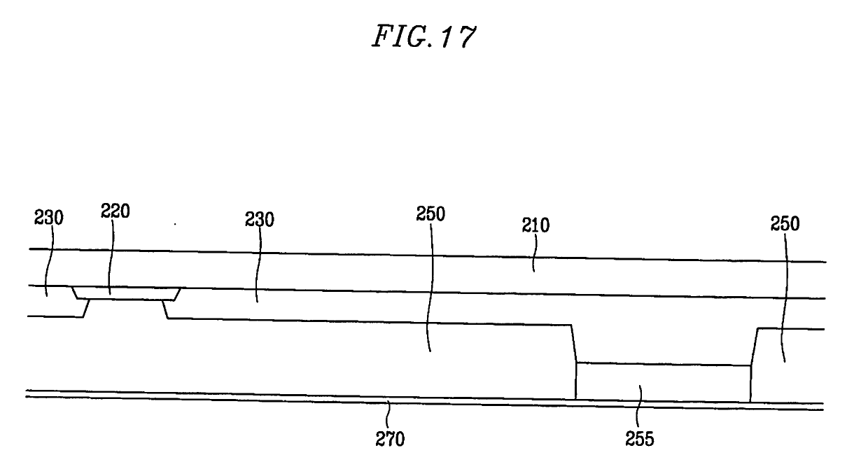

Next, as shown in FIG. 17, a common electrode 270 made of ITO or IZO is then formed on the retardation layer 250 and the isotropic medium layer 255.

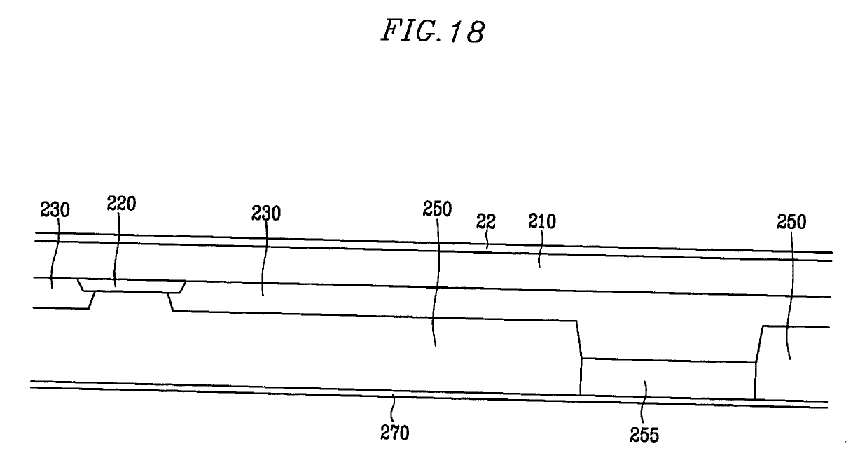

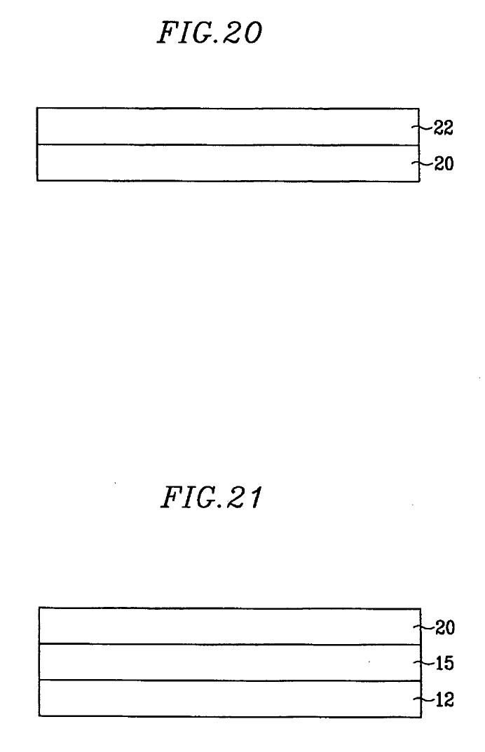

Then, as shown in FIG. 18, an upper polarizer 22 is attached to the outer surface of the upper insulating substrate 210. At this time, the transmission axis of the polarizer 22 is perpendicular to the transmission axis of the lower polarizer 12. The upper polarizer 22 is bonded to the substrate 210 using an adhesive, and this structure is shown in FIG. 20.

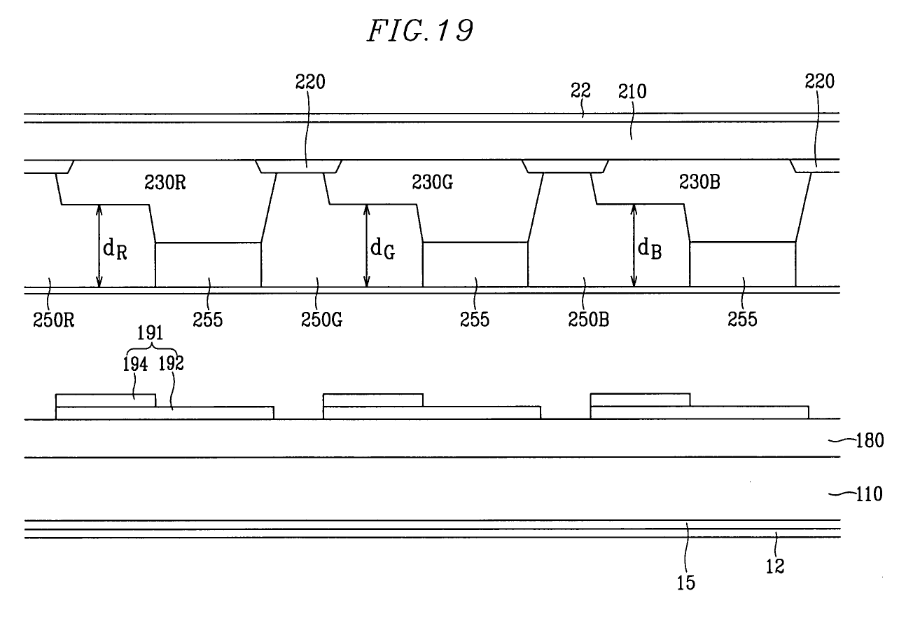

FIG. 19 is a cross-sectional view of RGB pixels of an LCD according to an embodiment of the present invention.

This figure shows a set of red, green, and blue pixels. Three portions 250R, 250G, and 250B of the retardation layer 250, related to a set of the RGB color filters 230, are differently formed in their thickness (which are represented as d_{R}, d_{G}, and d_{B} in FIG. 19). Generally, a retardation value is obtained by multiplying difference of refractive indexes of the retardation layer 250 between the fast axis and the slow axis by a thickness of the retardation layer 250. Refractive index of a medium varies depending on wave length of passing light and refractive index of a medium increases along with shortening of wavelength, Light has different wavelengths depending on its color. For this reason, the retardation layer 250 is formed to have different thickness depending upon the kind of the color filters. Since refractive index of a medium increases along with shortening of wavelength, difference of refractive indexes of the retardation layer 250 between the fast axis and the slow axis also increase along with shortening of wavelength. Accordingly, to induce the same retardation with respect to all of red, green and blue light, thickness of the retardation layer 250 is preferably increased along with lengthening of wavelength. In detail, since red light has a wavelength of about 640 nm, green light about 550 nm, and blue about 460 nm, the thickness of the three portions 250R, 250G, and 250B has correlation of d_{R}>d_{G}>d_{B}.

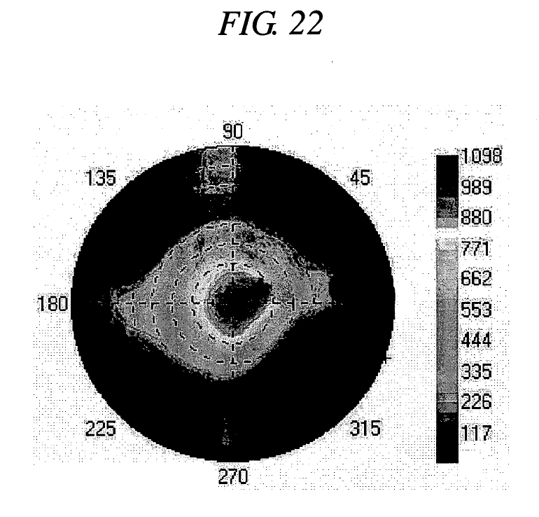

FIG. 22 shows the contrast ratio CR depending on angles of an LCD according to an embodiment of the present invention.

Generally, the term “viewing angle” means a cone perpendicular to the LCD in which the contrast ratio exceeds 10. As shown in FIG. 22, the contrast ratio of this LCD exceeds 10, even 80 at nearly all positions. This verifies that the LCD of this invention has a wide viewing angle.

As mentioned above, in the present invention, the retardation layer is formed to correspond to the reflection areas and the compensation film is interposed between the lower polarizer and the lower substrate, so that the viewing angle of the transflective LCD becomes wider. Furthermore, since the retardation layer is formed inside the LCD, other retardation layers are not additionally required. Accordingly, production cost of the LCD is reduced.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A liquid crystal display with a transmission area and a reflection area, comprising:
a first substrate;
a second substrate that is opposite to the first substrate;
a transparent electrode formed on the first substrate;
a reflective electrode formed on the transparent electrode and placed at the reflection area;
a retardation layer formed on the second substrate;
a first polarizer and a second polarizer that are respectively attached to outer surfaces of the first and second substrates; and
a compensation film provided between the first substrate and the first polarizer,
wherein the reflection area is a display region corresponding to the reflective electrode, and the transmission area is the remaining display region that is not the reflection area, and
wherein the retardation layer is placed at the reflection area.

2. The liquid crystal display of claim 1, further comprising an optically isotropic medium layer that is formed in the second substrate at the transmission area.

3. The liquid crystal display of claim 1, further comprising an optically isotropic medium layer that is formed in the second substrate throughout the transmission area and the reflection area.

4. The liquid crystal display of claim 1, wherein the first polarizer has a transmission axis that is perpendicular to a transmission axis of the second polarizer.

5. The liquid crystal display of claim 4, wherein the compensation film has a slow axis that is formed in the same direction as the transmission axis of the first polarizer.

6. The liquid crystal display of claim 5, wherein the compensation film satisfies the following equations:
$$40 \leq {R}_{O} = ( {n}_{x} - {n}_{y} ) \times d \leq 60 , and$$
$$150 \leq {R}_{th} = ( \frac{( {n}_{x} + {n}_{y} )}{2} - {n}_{z} ) \times d \leq 250.$$
where nₓ, n_{y}, and n_{z} are refractive indices of the compensation film when light passes through it in X, Y, and Z directions, d is a thickness of the compensation film, Rₜₕ is a retardation value in a thickness direction, and Rₒ is a retardation value in a direction perpendicular to the thickness direction of the compensation film.

7. The liquid crystal display of claim 6, wherein Rₒ is about 50 and Rₜₕ is about 200.

8. The liquid crystal display of claim 1, wherein the compensation film is a biaxial film.

9. The liquid crystal display of claim 1, wherein the retardation layer is a λ/4 plate.

10. The liquid crystal display of claim 9, wherein the retardation layer has a fast axis that is formed at ±45° to the transmission axes of the first and second polarizers.

11. The liquid crystal display of claim 1, wherein the retardation layer is formed at the reflection area of the second substrate.

12. The liquid crystal display of claim 1, further comprising a set of three color filters formed on the second substrate.

13. The liquid crystal display of claim 12, wherein the three color filters are a red color filter, a green color filter, and a blue color filter.

14. The liquid crystal display of claim 12, wherein a color filter among the three color filters, which is formed at the transmission area, is formed more thickly than the others formed at the reflection area.

15. The liquid crystal display of claim 13, wherein the retardation layer includes three portions related to the three color filters, and the three portions have different thicknesses depending upon the kind of related color filters.

16. The liquid crystal display of claim 1, further comprising a common electrode formed on the second substrate.

17. The liquid crystal display of claim 16, wherein a distance between the common electrode and the reflection electrode, which are formed at the reflection area, is shorter than a distance between the common electrode and the transparent electrode, which are formed at the transmission area.

18. The liquid crystal display of claim 17, wherein the distance at the reflection area is half of the distance at the transmission area.

19. The liquid crystal display of claim 1, wherein the compensation film is coated on either surface of the first polarizer.

20. The liquid crystal display of claim 1, wherein a pixel electrode formed by the transparent electrode and the reflective electrode has an uneven top surface.
